(19) United States
(12) Patent Application Publication
(10) Pub. No.: US 2018/0092019 A1
(43) Pub. Date: Mar. 29, 2018

(54) USER EQUIPMENT APPARATUS

(71) Applicant: NTT DOCOMO, INC., Tokyo (JP)

(72) Inventors: Shimpei Yasukawa, Tokyo (JP); Hiroki Harada, Tokyo (JP); Satoshi Nagata, Tokyo (JP); Qun Zhao, Beijing (CN)

(73) Assignee: NTT DOCOMO, INC., Tokyo (JP)

(21) Appl. No.: 15/560,637

(22) PCT Filed: Mar. 9, 2016
(86) PCT No.: PCT/JP2016/057374

§ 371 Date: Sep. 22, 2017

(30) Foreign Application Priority Data
Mar. 31, 2015 (JP) 2015-074187

(51) Int. Cl. H04W 40/14; H04W 48/10; H04W 76/00; H04W 76/06

(52) U.S. Cl. CPC H04W 40/14; H04W 48/10; H04W 88/04; H04W 76/068; H04W 76/002

(57) ABSTRACT

A user equipment apparatus acting as a relay terminal to relay data between a remote terminal and a base station includes a transmission unit configured to transmit to the remote terminal a groupcast ID which is a destination for the data; a reception unit configured to receive a connection release request from the remote terminal; and a connection management unit configured to release a connection to the remote terminal when the connection release request is received from the remote terminal.

### TECHNICAL FIELD

The present invention relates to D2D (user equipment-to-user equipment) communication and specifically relates to a user equipment apparatus, a connection management method, and an address setting method for managing a connection in D2D communication.

### BACKGROUND ART

In a current mobile communication system such as an LTE (Long Term Evolution) system, communication between user equipment apparatuses UEs is typically performed via a base station eNB or the like by means of communication between the user equipment apparatuses UEs and the base station eNB. Recently, various techniques on D2D communication (also referred to as “Side Link communication” and hereinafter referred to as “D2D”) for direct communication between user equipment apparatuses UEs are under discussion.

In D2D communication in an LTE system, in particular, “Communication” is proposed in order for user equipment apparatuses UEs to perform data communication such as a push call, and “Discovery” is also proposed in order for a receiving user equipment apparatus UE to detect a transmitting user equipment apparatus UE by using a transmitted Discovery signal including an ID of the user equipment apparatus UE, an application ID, or the like (see Non-Patent Document 1). It is expected that Communication will be applied to public safety (police or fire radio and so on), for example.

For Communication and Discovery, synchronization between user equipment apparatuses UEs is needed. In this regard, a user equipment apparatus (in-coverage user equipment apparatus) UE in coverage of a base station eNB can relay a synchronization signal received from the base station eNB to a user equipment apparatus (out-of-coverage user equipment apparatus) UE outside coverage of the base station eNB. As a result, the user equipment apparatus UE outside coverage of the base station eNB can identify a synchronization timing of the base station eNB.

### PRIOR ART DOCUMENT

### Non-Patent Document

[Non-Patent Document 1] 3GPP TR 36.843 V12.0.1 (2014-03)

[Non-Patent Document 2] 3GPP TS 23.303 V12.2.0 (2014-09)

### DISCLOSURE OF INVENTION

### Problem(s) to be Solved by the Invention

It is expected in the future that D2D communication will be used to extend coverage of a base station eNB, not only by relaying, by a user equipment apparatus UE in coverage of the base station eNB, a synchronization signal received from the base station eNB to a user equipment apparatus UE outside coverage of the base station eNB, but also by relaying data between the base station eNB and the user equipment apparatus UE outside coverage of the base station eNB. In other words, a user equipment apparatus UE (hereinafter referred to as a “relay terminal”) with a signal relay capability in coverage of the base station eNB can relay to the base station eNB data received from a user equipment apparatus UE (hereinafter referred to as a “remote terminal”) outside coverage of the base station eNB, and also relay to the remote terminal UE data received from the base station eNB (hereinafter referred to as “D2D relay”), thereby the remote terminal UE can communicate with the base station eNB. The remote terminal is not limited to a user equipment apparatus UE outside coverage of the base station eNB but may be a user equipment apparatus UE in coverage of the base station eNB. For example, a user equipment apparatus UE cannot access a network, when the user equipment apparatus UE is situated outside coverage of the base station eNB and cannot receive a synchronization signal or broadcast information from the base station eNB, when the user equipment apparatus UE uses a synchronization signal transmitted from another user equipment apparatus UE as a synchronization source, when an RRC connection procedure is not completed, or the like. In these situations, the user equipment apparatus UE can communicate with the base station eNB as a remote terminal. It is under discussion that D2D relay is implemented on an IP layer (see Non-Patent Document 2).

In D2D relay, communication quality between a remote terminal UE and a base station eNB depends on communication quality between the remote terminal UE and a relay terminal UE and communication quality between the relay terminal UE and the base station eNB. When the relay terminal UE is not suitable for D2D relay due to a change in communication quality, the remote terminal UE needs to select another relay terminal UE. In addition, when the remote terminal UE moves in coverage of the base station eNB, the remote terminal UE can communicate with the base station eNB without communicating with the relay terminal UE. Furthermore, when a user equipment apparatus UE in communication with the base station eNB moves outside coverage of the base station eNB, the user equipment apparatus UE needs to connect to the relay terminal UE as a remote terminal UE.

As described above, due to a change in communication between the remote terminal UE and the base station eNB or the like, a communication route in D2D relay may be also changed. Upon the change in the communication route, it is desirable to maintain the network connection. For example, assuming that D2D relay is implemented on an IP layer, when the remote terminal UE connects to another relay terminal UE or the base station eNB, a procedure for setting an IP address is performed after a connection is established on a lower layer such as an MAC layer. During the connection procedure, the network connection may be interrupted.

It is an object of the present invention to stabilize the connection between the remote terminal UE and the base station eNB when the communication route in D2D relay is changed.

### Means for Solving the Problem(s)

In one aspect of the present invention, there is provided a user equipment apparatus acting as a relay terminal to relay data between a remote terminal and a base station, including:
a transmission unit configured to transmit to the remote terminal a groupcast ID which is a destination for the data;
a reception unit configured to receive a connection release request from the remote terminal; and
a connection management unit configured to release a connection to the remote terminal when the connection release request is received from the remote terminal.

In another aspect of the present invention, there is provided a user equipment apparatus acting as a remote terminal to communicate with a base station via a relay terminal with a capability of relaying data, including:
a connection management unit configured to establish a link between the user equipment apparatus and the relay terminal and between the user equipment apparatus and another relay terminal;
a reception unit configured to receive from the relay terminal a groupcast ID which is a destination for the data; and
a transmission unit configured to transmit the data based on the groupcast ID;
wherein the transmission unit further transmits a connection release request to the relay terminal.

In another aspect of the present invention, there is provided a user equipment apparatus acting as a relay terminal to relay data between a remote terminal and a base station, including:
a reception unit configured to receive address information from the remote terminal, the base station, or another relay terminal; and
an IP address setting unit configured to set an IP address according to the received address information.

In another aspect of the present invention, there is provided a user equipment apparatus acting as a relay terminal to relay data between a remote terminal and a base station, including:
a reception unit configured to receive connection information indicating that the remote terminal is connected to the base station; and
a connection management unit configured to release a connection to the remote terminal, when the connection information is received.

In another aspect of the present invention, there is provided a user equipment apparatus acting as a remote terminal to communicate with a base station via a relay terminal with a capability of relaying data, including:
a connection management unit configured to connect to the base station when the user equipment apparatus moves in coverage of the base station; and
a transmission unit configured to transmit to the relay terminal connection information indicating that the user equipment apparatus is connected to the base station;
wherein the connection management unit releases a connection to the relay terminal, when the connection information indicating that the user equipment apparatus is connected to the base station is transmitted to the relay terminal.

In another aspect of the present invention, there is provided a user equipment apparatus for communicating with a base station, including:
a quality measurement unit configured to measure link quality between the user equipment apparatus and the base station;
a transmission unit configured to transmit a connection request to a relay terminal for relaying data between the user equipment apparatus and the base station, when the link quality between the user equipment apparatus and the base station is below a predetermined threshold; and
a connection management unit configured to establish a connection to the relay terminal.

### Advantageous Effect of the Invention

According to the present invention, it is possible to stabilize a connection between a remote terminal UE and a base station eNB when a communication route in D2D relay is changed.

### BRIEF DESCRIPTION OF THE DRAWINGS

FIG. 1 shows a schematic diagram of a communication system in accordance with an embodiment of the present invention.

FIG. 2 shows a layer structure of D2D relay.

FIG. 3 shows a sequence diagram of a procedure for setting an IP address in a remote terminal (an example where IPv4 is used).

FIG. 4 shows a sequence diagram of a procedure for setting an IP address in a remote terminal (an example where IPv6 is used).

FIG. 5 shows a sequence diagram of a procedure in which a remote terminal selects another relay terminal.

FIG. 6 shows a block diagram of a relay terminal in accordance with an embodiment of the present invention.

FIG. 7 shows a block diagram of a remote terminal in accordance with an embodiment of the present invention.

FIG. 8 shows a sequence diagram of a communication procedure in multi-links.

FIG. 9 shows a sequence diagram of a procedure for continuously using an IP address.

FIG. 10 shows a sequence diagram of a procedure when a remote terminal moves in coverage of a base station.

FIG. 11 shows a sequence diagram of a procedure when a remote terminal moves outside coverage of a base station.

### DETAILED DESCRIPTION OF THE PREFERRED EMBODIMENTS

Embodiments of the present invention are described below with reference to the drawings.

<Overview of Operations in a Communication System>

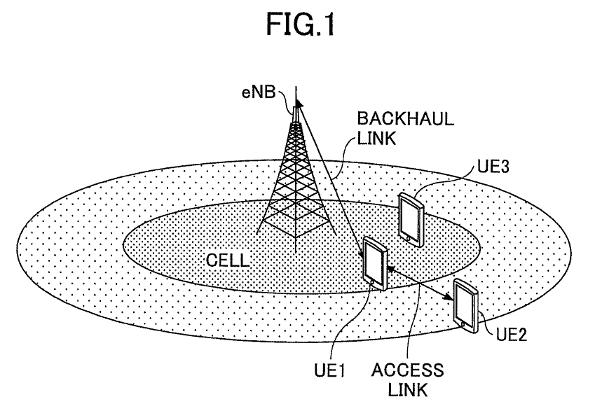

FIG. 1 shows a schematic diagram of a communication system in accordance with an embodiment of the present invention. The communication system in accordance with the embodiment of the present invention is a cellular communication system in which user equipment apparatuses UE1 and UE3 are situated in coverage (cell) of a base station eNB. The in-coverage user equipment apparatuses UE1 and UE3 have a D2D communication capability, and D2D communication can be performed with another in-coverage user equipment apparatus. The in-coverage user equipment apparatuses UE1 and UE3 can also perform D2D communication with an out-of-coverage user equipment apparatus UE2. The out-of-coverage user equipment apparatus UE2 also has a D2D communication capability, and D2D communication can be performed with another user equipment apparatus. In addition, the in-coverage user equipment apparatuses UE1 and UE3 can perform cellular communication with the base station eNB as usual.

The in-coverage user equipment apparatuses UE1 and UE3 are relay terminals with a signal relay capability and can relay to the base station eNB data received from the out-of-coverage user equipment apparatus UE2 that is a remote terminal. The in-coverage user equipment apparatuses UE1 and UE3 can also relay to the out-of-coverage user equipment apparatus UE2 data received from the base station eNB. When the remote terminal UE2 connects to the base station eNB via the relay terminal UE1, a link between the base station eNB and the relay terminal UE1 is referred to as a “backhaul link” and a link between the relay terminal UE1 and the remote terminal UE2 is referred to as an “access link”. While the remote terminal UE2 is situated outside coverage of the base station eNB in FIG. 1, the remote terminal UE2 may be situated in coverage of the base station eNB. For example, the user equipment apparatus UE2 cannot access a network, when the user equipment apparatus UE2 is situated outside coverage of the base station eNB and cannot receive a synchronization signal or broadcast information from the base station eNB, when the user equipment apparatus UE uses a synchronization signal transmitted from another user equipment apparatus as a synchronization source, when an RRC connection procedure is not completed, or the like. In these situations, the user equipment apparatus UE2 can communicate with the base station eNB as a remote terminal in or outside coverage of the base station.

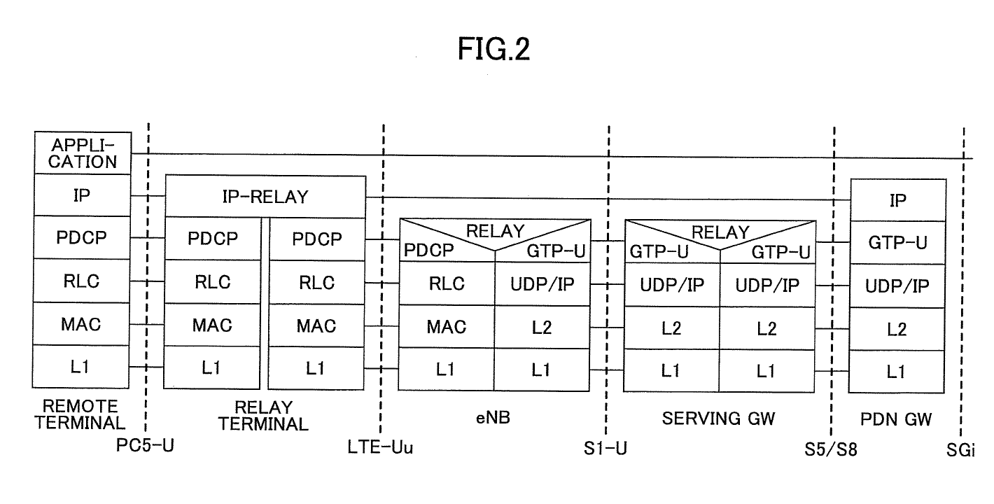

FIG. 2 shows a layer structure of D2D relay.

It is assumed that D2D relay is implemented on an IP layer. Specifically, in order to implement D2D relay, the remote terminal UE2 receives address information from the relay terminal UE1 to set an IP address. For example, when IPv4 is used, the remote terminal UE2 receives an IP address allocated according to a DHCP (Dynamic Host Configuration Protocol) and sets the IP address. For example, when IPv6 is used, the remote terminal UE2 transmits an RS (Router Solicitation) to the relay terminal UE1 and receives prefix information called an RA (Router Advertisement) from the relay terminal UE1. The remote terminal UE2 sets an IP address based on the received prefix information. In this manner, the remote terminal UE2 receives address information (an IP address allocated according to a DHCP or prefix information called an RA) for setting an IP address from the relay terminal UE1, sets the IP address, and transmits an IP packet to the relay terminal UE1 on the IP layer. The IP packet is encapsulated according to a GTP (GPRS Tunneling Protocol) and transmitted over a core network (Serving GW, PDN GW).

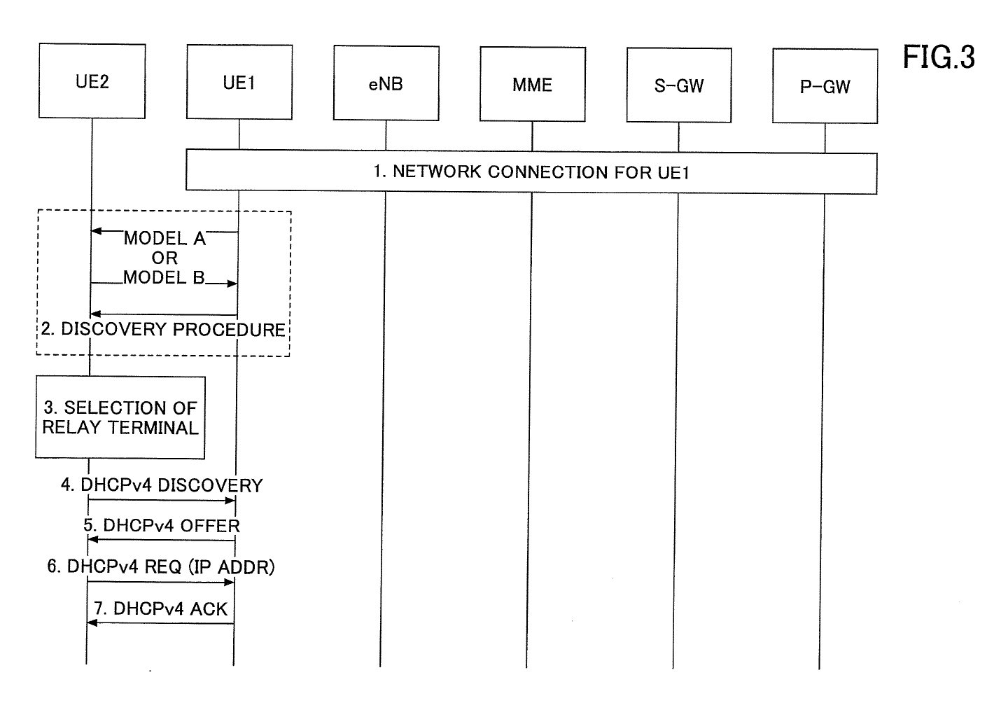

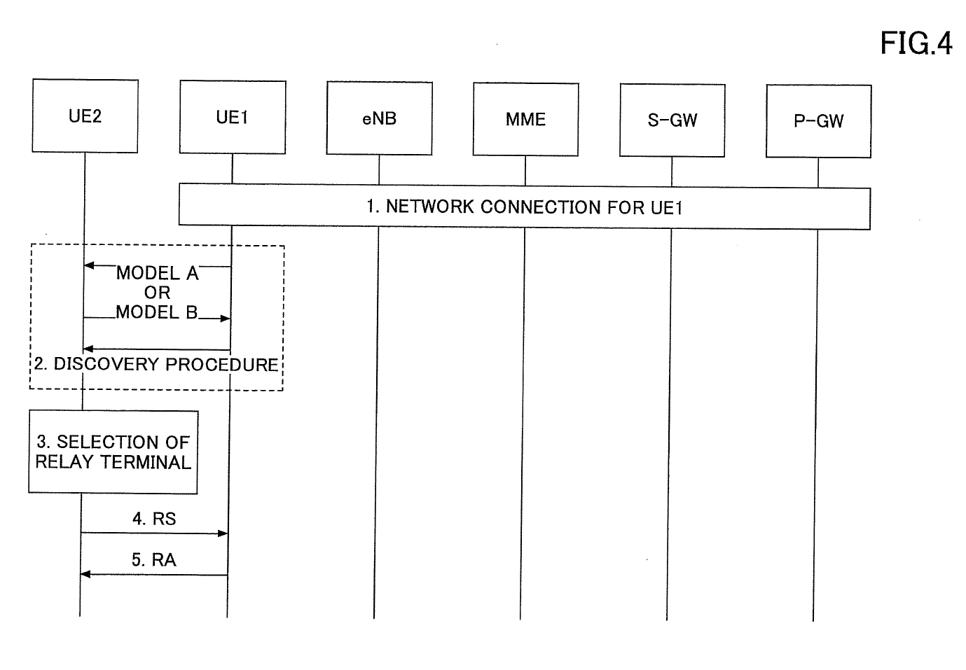

With reference to FIGS. 3 and 4, a procedure for setting an IP address in the remote terminal UE2 is further described below. A procedure for setting an IP address when the remote terminal UE2 initially connects to the relay terminal UE1 is performed as described below.

It is assumed that the relay terminal UE1 has already been accessing a network. First, the remote terminal UE2 needs to discover the relay terminal UE1. The relay terminal UE1 may notify the remote terminal UE2 of the presence of the relay terminal UE1 (Model A). Alternatively, the remote terminal UE2 may detect the relay terminal UE1 in the proximity of the remote terminal UE2 (Model B). In either case, the remote terminal UE2 discovers the relay terminal UE1 in its proximity and selects the relay terminal UE1.

When IPv4 is used, as shown in FIG. 3, the remote terminal UE2 transmits a DHCP Discovery to the relay terminal UE1 and receives a DHCP Offer which includes a candidate for an IP address. Then, the remote terminal UE2 transmits a DHCP request to finally obtain the candidate for the IP address, receives a DHCP ACK which is a response to the DHCP request, and sets the IP address.

When IPv6 is used, as shown in FIG. 4, the remote terminal UE2 transmits an RS to the relay terminal UE1 and requests prefix information for setting an IP address. The remote terminal UE2 receives an RA including the prefix information, combines the RA and an MAC address of the remote terminal UE2, and sets an IP address.

When the IP address is set as described above, the remote terminal UE2 connects to the base station eNB via the relay terminal UE1.

On the other hand, communication quality between the remote terminal UE2 and the base station eNB depends on communication quality of the access link and communication quality of the backhaul link. When the relay terminal UE1 is not suitable for D2D relay due to a change in communication quality, the remote terminal UE2 needs to select another in-coverage relay terminal UE3.

When the procedure for setting an IP address as described with reference to FIG. 3 or FIG. 4 is performed while the remote terminal UE2 connects to the other relay terminal UE3, the network connection may be interrupted. More specifically, the network connection is interrupted from the instant when the remote terminal UE2 releases the connection to the relay terminal UE1 to the instant when an IP address is set to connect the other relay terminal UE3. In an embodiment of the present invention, in order to avoid the interruption and stabilize the connection between the remote terminal UE2 and the base station eNB, the following solutions are provided.

(1) Selection of the other relay terminal UE3 during the connection to the currently-connected relay terminal UE1

(2) Establishment of multi-links to both the currently-connected relay terminal UE1 and the other relay terminal UE3

(3) Continuous use of the IP address used for communication with the currently-connected relay terminal UE1

In addition, when the remote terminal UE2 moves in coverage of the base station eNB, the remote terminal UE2 can communicate with the base station eNB without communicating with the relay terminal UE1. Furthermore, when an in-coverage user equipment apparatus moves outside coverage of the base station eNB, the in-coverage user equipment apparatus needs to connect to the relay terminal UE1 or UE3 as a remote terminal UE. In these situations, the network connection may be interrupted. In an embodiment of the present invention, in order to avoid the interruption and stabilize the connection between the remote terminal UE2 and the base station eNB, the following solutions are provided.

(4) Connection to the base station eNB when the relay terminal moves in coverage of the base station eNB

(5) Connection to the relay terminal UE1 or UE3 when the user equipment apparatus moves outside coverage of the base station eNB

Each of these solutions is specifically described below.

(1) Selection of the other relay terminal UE3 during the connection to the currently-connected relay terminal UE1

When the remote terminal UE2 receives a notification of quality degradation from the relay terminal UE1 during communication with the relay terminal UE1, for example, the remote terminal UE2 selects another relay terminal UE3 and transmits to the relay terminals UE1 and UE3 a change request for changing from the relay terminal UE1 to the relay terminal UE3. By allowing the remote terminal UE2 to select the other relay terminal UE3 when the relay terminal UE1 is not suitable for D2D relay, the connection between the remote terminal UE2 and the base station eNB can be stabilized.

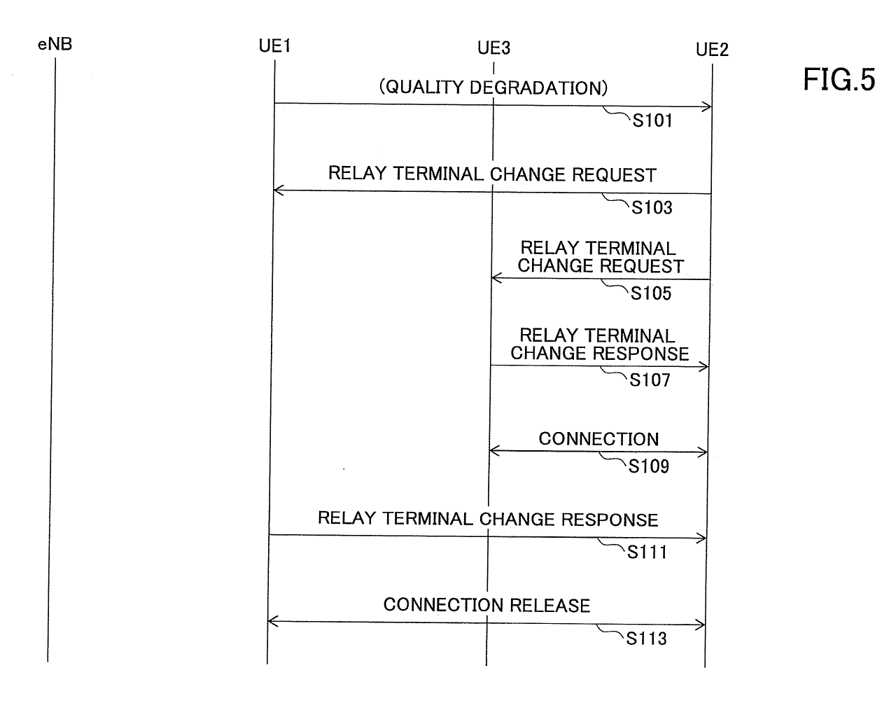

FIG. 5 shows a sequence diagram of a procedure in which the remote terminal UE2 selects the other relay terminal UE3.

The relay terminal UE1 may measure quality of the backhaul link and notify the remote terminal UE2 of quality degradation when quality of the backhaul link is degraded (S101). The relay terminal UE1 may also measure quality of the access link and notify the remote terminal UE2 of quality degradation when quality of the access link is degraded.

When the remote terminal UE2 receives the notification of quality degradation from the relay terminal UE1, the remote terminal UE2 selects the other relay terminal UE3 and transmits a change request for changing the relay terminal to the currently-connected relay terminal UE1 and the other relay terminal UE3 (S103, S105). The currently-connected relay terminal UE1 or the other relay terminal UE3 may report to the base station eNB that the change request for changing the relay terminal is received, so that dual connections between the relay terminal UE1 and the remote terminal UE2 and between the relay terminal UE3 and the remote terminal UE2 can be allowed for a predetermined period of time. It should be noted that selection of the other relay terminal UE3 may be periodically performed. For example, the remote terminal UE2 may periodically transmit a D2D signal for quality measurement to allow the relay terminal UE1 and the other relay terminal UE3 to measure quality and to allow the relay terminal UE1 to determine whether to maintain the relay connection. When quality of the other relay terminal UE3 is higher than quality of the relay terminal UE1, the relay terminal UE1 may notify the remote terminal UE2 of quality degradation so as to allow the remote terminal UE2 to periodically select the other relay terminal UE3.

While FIG. 5 shows that the remote terminal UE2 transmits a change request for changing the relay terminal in response to the notification of quality degradation from the relay terminal UE1, the remote terminal UE2 or the base station eNB may transmit a change request for changing the relay terminal by its own decision because there are no data to be transmitted, for example.

When the other relay terminal UE3 receives the change request for changing the relay terminal, the other relay terminal UE3 transmits a response to the change request to the remote terminal UE2 (S107), and then a connection is established between the other relay terminal UE3 and the remote terminal UE2 (S109).

When the currently-connected relay terminal UE1 receives the change request for changing the relay terminal, the currently-connected relay terminal UE1 transmits a response to the change request to the remote terminal UE2 (S111), and then the connection between the currently-connected relay terminal UE1 and the remote terminal UE2 is released (S113). Even if a response to the change request is not received, the currently-connected relay terminal UE1 and the remote terminal UE2 may autonomously release the connection when a predetermined period of time (a period of time set by the currently-connected relay terminal UE1 or a period of time set in advance) has elapsed since the change request for changing the relay terminal is transmitted and received. By using this operation, a response to the change request for changing the relay terminal may be omitted.

While FIG. 5 shows that each of the currently-connected relay terminal UE1 and the other relay terminal UE3 transmits a response to the change request for changing the relay terminal, the change request for changing the relay terminal may be transmitted from each of the currently-connected relay terminal UE1 and the other relay terminal UE3 to the base station eNB and a response to the change request may be transmitted from the base station eNB to the remote terminal UE2 via the relay terminals UE1 and UE3 according to the decision by the base station eNB.

It should be noted that the connection to the other relay terminal UE3 (S109) and the release of the connection from the currently-connected relay terminal UE1 (S113) may be performed in different order from the order shown in FIG. 5. In view of stabilizing the connection between the remote terminal UE2 and the base station eNB, it is desirable to release the connection from the currently-connected relay terminal UE1 (S113) after the connection to the other relay terminal UE3 is established (S109), as described below.

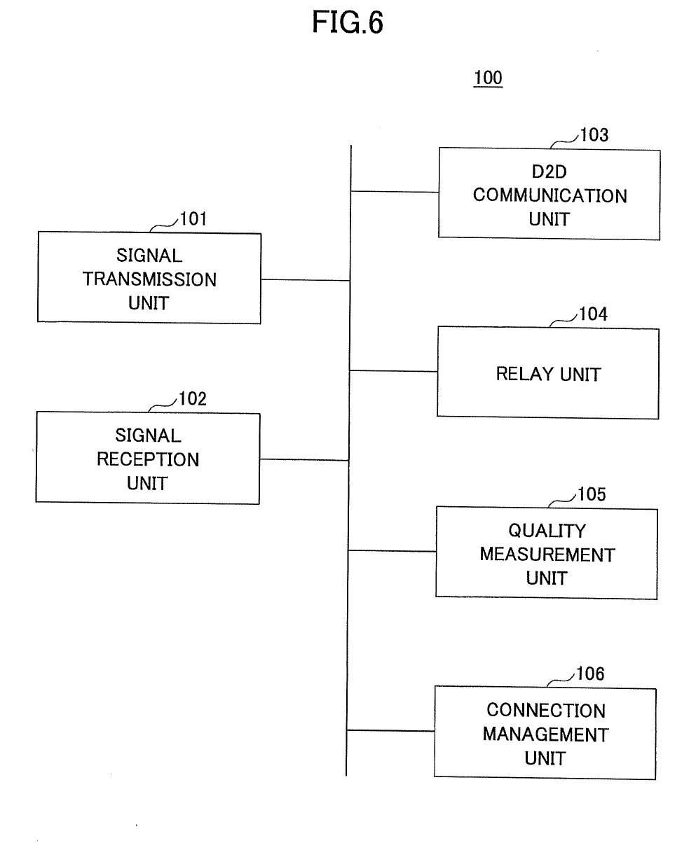

FIG. 6 shows a block diagram of a relay terminal in accordance with an embodiment of the present invention. The relay terminal 100 includes a signal transmission unit 101, a signal reception unit 102, a D2D communication unit 103, a relay unit 104, a quality measurement unit 105, and a connection management unit 106. It should be noted that FIG. 6 merely shows functional units in the relay terminal 100 specifically associated with the embodiment of the present invention, and thus the relay terminal 100 may include other functional units (not shown) for at least performing operations complying with LTE or the like. In addition, the configuration shown in FIG. 6 is presented for illustration only. Any division between functional units or any name of a functional unit may be applied as long as the operations in accordance with the embodiment can be performed.

The relay terminal 100 may be an information and communication terminal including a processor such as a CPU (central processing unit), a memory device such as a RAM (random access memory) and a ROM (read only memory), a storage device such as a hard disk, and so on. For example, each functional unit or the like in the relay terminal 100 may be implemented in the processor and the storage device or the memory device and realized by processing data or executing a program stored in the storage device or the memory device in the processor.

The signal transmission unit 101 generates various signals on a physical layer from signals on a higher layer to be transmitted from the relay terminal 100 and wirelessly transmits the generated signals. The signal transmission unit 101 includes transmission functionality for D2D communication and transmission functionality for cellular communication.

The signal reception unit 102 wirelessly receives various signals on a physical layer from another user equipment apparatus UE or the base station eNB and obtains signals on a higher layer from the received signals. The signal reception unit 102 includes reception functionality for D2D communication and reception functionality for cellular communication.

The D2D communication unit 103 includes functionality for a D2D application and performs resource allocation to a Discovery signal and transmission and reception control of the Discovery signal, resource allocation to SCI (Sidelink Control Information)/data and transmission and reception control of the SCI/data, or the like.

The relay unit 104 includes functionality for implementing D2D relay. Specifically, when data received by the signal reception unit 102 from the remote terminal UE2 is to be transmitted to the base station eNB, the relay unit 104 transmits the data to the base station eNB via the signal transmission unit 101. On the other hand, when data received by the signal reception unit 102 from the base station eNB is to be transmitted to the remote terminal UE2, the relay unit 104 transmits the data to the remote terminal UE2 via the signal transmission unit 101.

The quality measurement unit 105 measures quality of a backhaul link and quality of an access link. When the measured quality is below a predetermined threshold, the quality measurement unit 105 may transmit quality degradation notification to the remote terminal UE2 or the base station eNB via the signal transmission unit 101.

The connection management unit 106 manages a connection to the remote terminal UE2. The connection management unit 106 establishes an access link to the remote terminal UE2 in response to a connection request from the remote terminal UE2 or a change request for changing the relay terminal (in the case where the connection to the other relay terminal UE3 is switched to a connection to the relay terminal 100). The connection management unit 106 also releases the connection to the remote terminal 100 in response to a connection release request from the remote terminal UE2 or a change request for changing the relay terminal (in the case where the connection to the relay terminal 100 is switched to a connection to the other relay terminal UE3). Alternatively, the connection management unit 106 may release the connection to the remote terminal UE2 when a predetermined period of time has elapsed since a connection release request or a change request for changing the relay terminal is received without responding to the connection release request or the change request for changing the relay terminal.

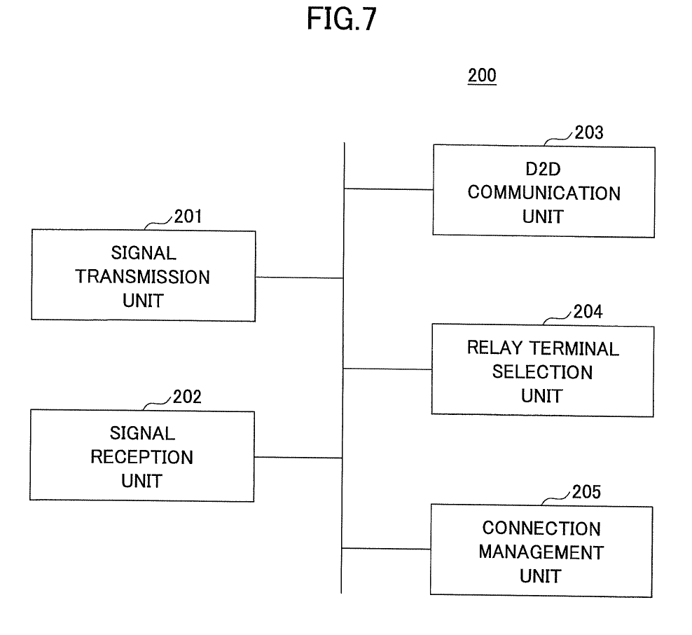

FIG. 7 shows a block diagram of a remote terminal in accordance with an embodiment of the present invention. The remote terminal 200 includes a signal transmission unit 201, a signal reception unit 202, a D2D communication unit 203, a relay terminal selection unit 204, and a connection management unit 205. It should be noted that FIG. 7 merely shows functional units in the remote terminal 200 specifically associated with the embodiment of the present invention, and thus the remote terminal 200 may include other functional units (not shown) for at least performing operations complying with LTE or the like. In addition, the configuration shown in FIG. 7 is presented for illustration only. Any division between functional units or any name of a functional unit may be applied as long as the operations in accordance with the embodiment can be performed.

The remote terminal 200 may be an information and communication terminal including a processor such as a CPU (central processing unit), a memory device such as a RAM (random access memory) and a ROM (read only memory), a storage device such as a hard disk, and so on. For example, each functional unit or the like in the remote terminal 200 may be implemented in the processor and the storage device or the memory device and realized by processing data or executing a program stored in the storage device or the memory device in the processor.

The signal transmission unit 201 generates various signals on a physical layer from signals on a higher layer to be transmitted from the remote terminal 200 and wirelessly transmits the generated signals. The signal transmission unit 201 includes transmission functionality for D2D communication and transmission functionality for cellular communication.

The signal reception unit 202 wirelessly receives various signals on a physical layer from another user equipment apparatus UE or the base station eNB and obtains signals on a higher layer from the received signals. The signal reception unit 202 includes reception functionality for D2D communication and reception functionality for cellular communication.

The D2D communication unit 203 includes functionality for a D2D application and performs resource allocation to a Discovery signal and transmission and reception control of the Discovery signal, resource allocation to SCI/data and transmission and reception control of the SCI/data, or the like.

The relay terminal selection unit 204 manages a candidate for a relay terminal to select a relay terminal suitable for D2D relay, by receiving information about the availability of D2D relay, information about quality, or the like from a relay terminal in the proximity of the relay terminal.

The connection management unit 205 manages connections to the relay terminals UE1 and UE3. The connection management unit 205 establishes an access link to the relay terminal UE3 when a response to a connection request or a change request for changing the relay terminal (in the case where the connection to the currently-connected relay terminal UE1 is switched to a connection to the other relay terminal UE3) is received from the relay terminal UE3. The connection management unit 205 also releases the connection to the relay terminal UE1 when a response to a connection release request or a change request for changing the relay terminal (in the case where the connection to the currently-connected relay terminal UE1 is switched to a connection to the other relay terminal UE3) is received from the relay terminal UE1. Alternatively, the connection management unit 205 may release the connection to the relay terminal UE1 when a predetermined period of time has elapsed since a connection release request or a change request for changing the relay terminal is transmitted, even if a response to the connection release request or the change request for changing the relay terminal is not received.

By allowing the remote terminal UE2 to select the relay terminal UE1 or UE3 suitable for D2D relay in this manner, a link failure in D2D relay can be avoided and the connection between the remote terminal UE2 and the base station eNB can be stabilized. In addition, by allowing the remote terminal UE2 to periodically select the other relay terminal UE3, delay in selecting the other relay terminal UE3 can be reduced.

(2) Establishment of multi-links to both the currently-connected relay terminal UE1 and the other relay terminal UE3

Even if the remote terminal UE2 selects the other relay terminal UE3, the currently-connected relay terminal UE1 continues D2D relay, so that multi-links can be established using both the currently-connected relay terminal UE1 and the other relay terminal UE3. With the establishment of multi-links, the connection between the remote terminal UE2 and the base station eNB can be maintained.

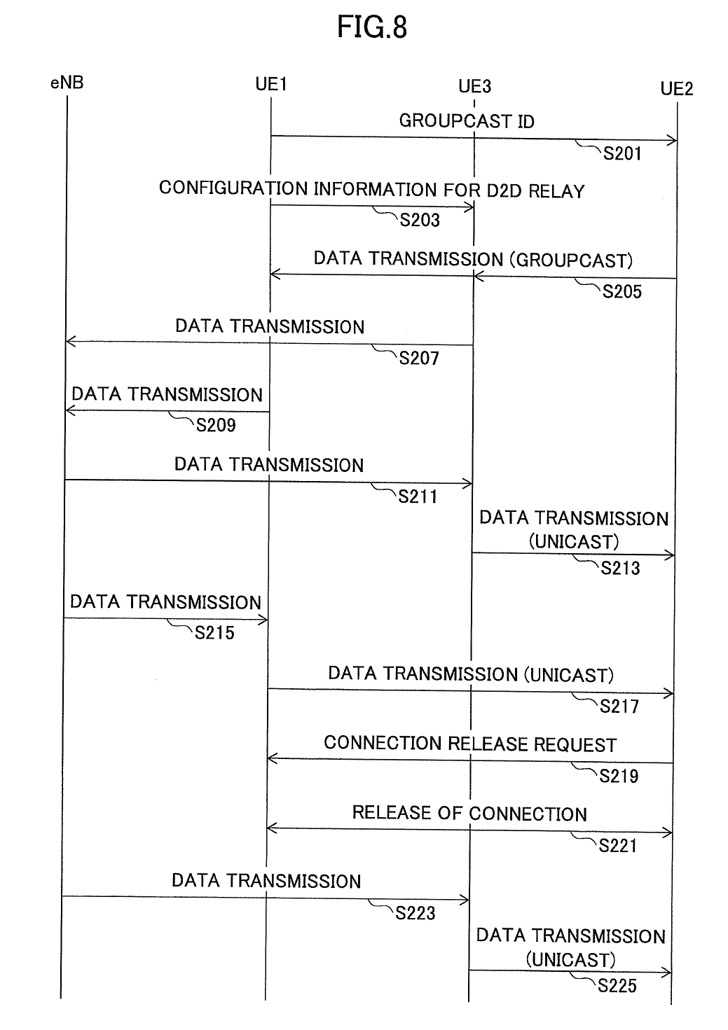

FIG. 8 shows a sequence diagram of a communication procedure in multi-links.

Before starting the sequence shown in FIG. 8, it is assumed that the remote terminal UE2 selects the other relay terminal UE3 and a connection to the other relay terminal UE3 has been established as described with reference to steps S103-S109 in FIG. 5. Thus, the remote terminal UE2 connects to the base station eNB via the relay terminal UE1 and also connects to the base station eNB via the relay terminal UE3.

In order to achieve communication with multi-links, the relay terminal UE1 transmits a groupcast ID which is a destination for data (S201).

The relay terminal UE1 further transmits configuration information (the groupcast ID, address information on layer 2/3 of the remote terminal UE2, resource information for D2D communication, or the like) for D2D relay to the other relay terminal UE3 (S203). It should be noted that the configuration information for D2D relay may be transmitted from the base station eNB or the remote terminal UE2 to the other relay terminal UE3.

The remote terminal UE2 groupcasts data to the relay terminals UE1 and UE3 according to the groupcast ID received from the relay terminal UE1 (S205). The relay terminals UE1 and UE3 transmit the received data to the base station eNB, respectively (S207, S209). When the base station eNB receives duplicate data, the base station eNB may discard either of the duplicate data.

When the relay terminal UE3 receives data to be transmitted to the remote terminal UE2 (S211), the relay terminal UE3 transmits the received data to the remote terminal UE2 (S213). In this case, unicast transmission is used.

Similarly, when the relay terminal UE1 receives data to be transmitted to the remote terminal UE2 (S215), the relay terminal UE1 transmits the received data to the remote terminal UE2 (S217). In this case, unicast transmission is also used. When the remote terminal UE2 receives duplicate data, the remote terminal UE2 may discard either of the duplicate data.

For example, in response to a connection release request from the remote terminal UE2 (S219), the relay terminal UE1 stops D2D relay and then the connection between the relay terminal UE1 and the remote terminal UE2 is released (S221). The connection release request is signaling for terminating D2D relay and may be a request for releasing an IP address, for example. It should be noted that the connection release request may be transmitted from the base station eNB to the relay terminal UE1. Alternatively, as described with reference to steps S111-S113 in FIG. 5, when the relay terminal UE1 responds to a change request from the remote terminal UE2 or when a predetermined period of time has elapsed from the change request, the connection between the relay terminal UE1 and the remote terminal UE2 may be released.

After the connection between the relay terminal UE1 and the remote terminal UE2 is released, communication between the base station eNB and the remote terminal UE2 is performed via the relay terminal UE3 (S223, S225).

When multi-links cannot be established between the remote terminal UE2 and the other relay terminal UE3, the remote terminal UE2 may not transmit a connection release request to the relay terminal UE1 to communicate with the base station via the relay terminal UE1.

The relay terminals UE1 and UE3 in accordance with this embodiment are configured as shown in FIG. 6. Specifically, in order to achieve communication with multi-links, the D2D communication unit 103, the relay unit 104, and the connection management unit 106 in the relay terminal UE1 are configured as described below.

The D2D communication unit 103 transmits a groupcast ID to the remote terminal UE2 via the signal transmission unit 101. The D2D communication unit 103 may also transmit configuration information for D2D relay to the other relay terminal UE3 via the signal transmission unit 101.

When data received from the remote terminal UE2 according to the groupcast ID is to be transmitted to the base station eNB, the relay unit 104 transmits the data to the base station eNB via the signal transmission unit 101.

The connection management unit 106 releases the connection to the remote terminal UE2 in response to a connection release request from the remote terminal UE2 or a change request for changing the relay terminal (in the case where the connection to the relay terminal 100 is switched to a connection to the other relay terminal UE3). Alternatively, the connection management unit 106 may release the connection to the remote terminal UE2 when a predetermined period of time has elapsed since a connection release request or a change request for changing the relay terminal is received without responding to the connection release request or the change request for changing the relay terminal. In this embodiment, since the connection to the remote terminal UE2 is maintained until a request from the remote terminal UE2 is received, communication with multi-links can be achieved when a connection has been established between the remote terminal UE2 and the other relay terminal UE3.

The remote terminal UE2 in accordance with this embodiment is configured as shown in FIG. 7.

In this embodiment, the D2D communication unit 203 transmits data to the relay terminals UE1 and UE3 via the signal transmission unit 101 according to the groupcast ID received from the relay terminal UE1. When duplicate data are received by the signal reception unit 202, the D2D communication unit 203 may discard either of the duplicate data.

The connection management unit 205 maintains the connection to the relay terminal UE1 until a response to a connection release request or a change request for changing the relay terminal (in the case where the connection to the currently-connected relay terminal UE1 is switched to a connection to the other relay terminal UE3) is received from the relay terminal UE1. When the response is received from the relay terminal UE1, the connection management unit 205 releases the connection to the relay terminal UE1. Alternatively, the connection management unit 205 may release the connection to the relay terminal UE1 when a predetermined period of time has elapsed since a connection release request or a change request for changing the relay terminal is transmitted, even if a response to the connection release request or the change request for changing the relay terminal is not received. In this embodiment, since the connection to the relay terminal UE1 is maintained until a request is transmitted to the relay terminal UE1, multi-link communication can be performed when a connection has been established between the remote terminal 200 and the other relay terminal UE3.

By establishing multi-links and groupcasting data from the remote terminal UE2 to the relay terminals UE1 and UE3, the connection between the remote terminal UE2 and the base station eNB can be maintained.

(3) Continuous use of the IP address used for communication with the currently-connected relay terminal UE1

Even if the remote terminal UE2 connects to the other relay terminal UE3, the remote terminal UE2 continuously uses the IP address used for communication with the currently-connected relay terminal UE1. By continuously using the IP address, a procedure for setting an IP address between the relay terminal UE3 and the remote terminal UE2 can be simplified and the connection on the IP layer between the remote terminal UE2 and the base station eNB can be maintained.

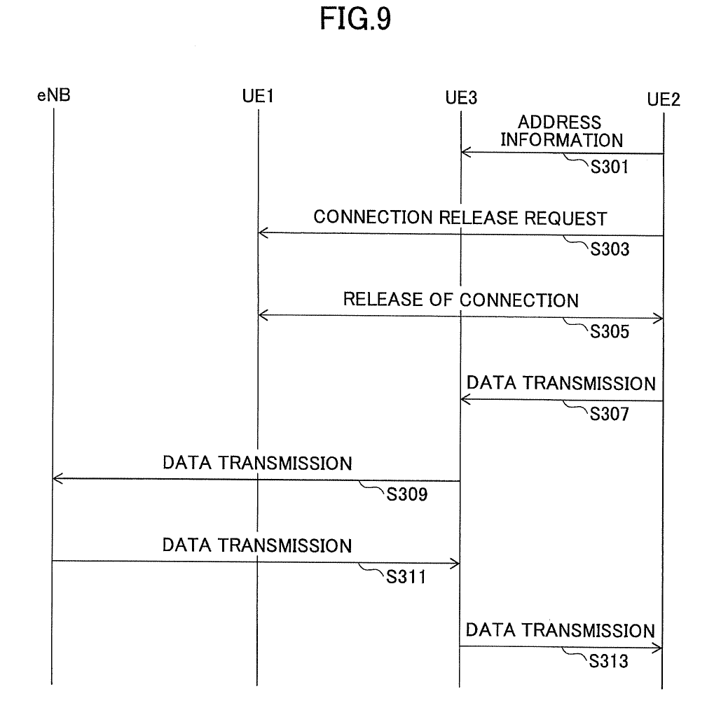

FIG. 9 shows a sequence diagram of a procedure for continuously using an IP address.

Before starting the sequence shown in FIG. 9, it is assumed that the remote terminal UE2 selects the other relay terminal UE3 and a connection to the other relay terminal UE3 has been established as described with reference to steps S103-S109 in FIG. 5. Thus, the remote terminal UE2 connects to the base station eNB via the relay terminal UE1 and also connects to the base station eNB via the relay terminal UE3.

In order to maintain the connection on the IP layer, the remote terminal UE2 transmits address information for setting an IP address to the other relay terminal UE3 (S301). For example, the address information is an IP address of the remote terminal UE2 in the case of IPv4 or prefix information for setting an IPv6 address in the case of IPv6. The address information may include a layer 2 ID of the remote terminal UE2 or a period of validity (expiration). The period of validity included in the address information is a period of time during which the remote terminal UE2 can continuously use the IP address. The relay terminal UE3 sets an IP address of the remote terminal UE2 according to the address information received from the remote terminal UE2. It should be noted that address information of the remote terminal UE2 may be transmitted from the currently-connected relay terminal UE1 or the base station eNB to the relay terminal UE3.

For example, in response to a connection release request from the remote terminal (S303), the relay terminal UE1 stops D2D relay and then the connection between the relay terminal UE1 and the remote terminal UE2 is released (S305). The connection release request is signaling for terminating D2D relay and may be a request for releasing an IP address, for example. In this embodiment, the request for releasing an IP address is treated as a request for terminating D2D relay only and the IP address is not released to maintain the connection on the IP layer. It should be noted that the connection release request may be transmitted from the base station eNB to the relay terminal UE1. Alternatively, as described with reference to steps S111-S113 in FIG. 5, when the relay terminal UE1 responds to a change request from the remote terminal UE2, the connection between the relay terminal UE1 and the remote terminal UE2 may be released.

The remote terminal UE2 transmits data to the relay terminal UE3 according to the IP address set for communication with the relay terminal UE1, even after the connection to the relay terminal UE1 is released (S307). The relay terminal UE3 transmits the received data to the base station eNB (S309).

When the relay terminal UE3 receives from the base station eNB data to be transmitted to the remote terminal UE2 (S311), the relay terminal UE3 transmits the received data to the remote terminal UE2 according to the set IP address (S313).

When the IP address cannot be set or when a connection on the IP layer cannot be established after the period of validity included in the address information, a procedure for setting an IP address according to a DHCP as shown in FIG. 3 or a procedure for setting an IP address using an RS/RA as shown in FIG. 4 may be performed. In this case, the remote terminal UE2 may include different IP addresses set for communication with the relay terminals UE1 and UE3, respectively.

The relay terminals UE1 and UE3 in accordance with this embodiment are configured as shown in FIG. 6. Specifically, in order to set an IP address of the remote terminal UE2 in the relay terminal UE3, the connection management unit 106 is configured as described below.

The connection management unit 106 sets an IP address of the remote terminal UE2 according to address information received from the remote terminal UE2. The connection management unit 106 need not perform a procedure for setting an IP address according to a DHCP as shown in FIG. 3 or a procedure for setting an IP address using an RS/RA as shown in FIG. 4 in order to set the IP address of the remote terminal UE2. However, when the IP address cannot be set or when a connection on the IP layer cannot be established after the period of validity included in the address information, the connection management unit 106 performs a procedure for setting an IP address according to a DHCP as shown in FIG. 3 or a procedure for setting an IP address using an RS/RA as shown in FIG. 4.

The remote terminal UE2 in accordance with this embodiment is configured as shown in FIG. 7.

In this embodiment, the connection management unit 205 continuously uses the IP address set for communication with the relay terminal UE1, even after a response to a connection release request or a change request for changing the relay terminal (in the case where the connection to the currently-connected relay terminal UE1 is switched to a connection to the other relay terminal UE3) is received from the relay terminal and then the connection to the relay terminal UE1 is released. However, when the IP address cannot be set for communication with the relay terminal UE3 or when a connection on the IP layer cannot be established after the period of validity included in the address information, the connection management unit 205 performs a procedure for setting an IP address according to a DHCP as shown in FIG. 3 or a procedure for setting an IP address using an RS/RA as shown in FIG. 4.

By continuously using the IP address, a procedure for setting an IP address according to a DHCP or using an RS/RA need not be performed between the remote terminal UE2 and the relay terminal UE3 and the connection on the IP layer between the remote terminal UE2 and the base station eNB can be maintained.

(4) Connection to the base station eNB when the relay terminal moves in coverage of the base station eNB

When the remote terminal UE2 moves in coverage of the base station eNB, the remote terminal UE2 can communicate with the base station eNB without communicating with the relay terminal UE1. In this situation, by maintaining the connection to the relay terminal UE1 until a connection between the remote terminal UE2 and the base station eNB is established, the connection between the remote terminal UE2 and the base station eNB can be stabilized.

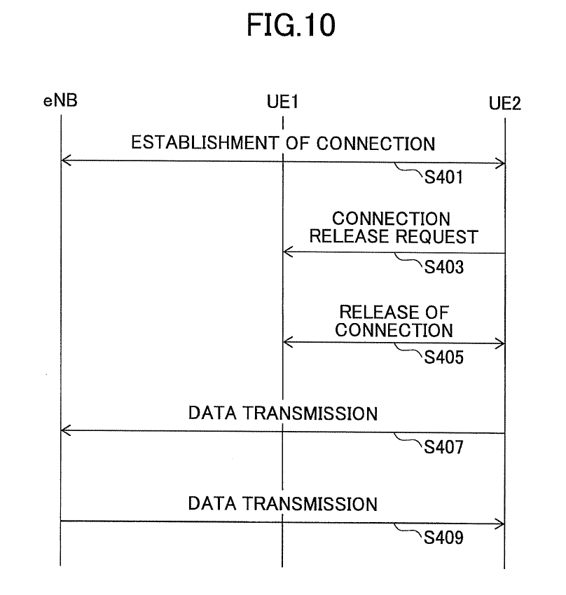

FIG. 10 shows a sequence diagram of a procedure when the remote terminal UE2 moves in coverage of the base station eNB.

When the remote terminal UE2 moves in coverage of the base station eNB while the remote terminal UE2 communicates with the relay terminal, the remote terminal UE2 establishes a connection to the base station eNB (S401).

When the remote terminal UE2 establishes the connection to the base station eNB, the remote terminal UE2 transmits a connection release request to the relay terminal UE1 (S403) and then the connection between the remote terminal UE2 and the relay terminal UE1 is released. It should be noted that the connection release request may be transmitted from the base station eNB to the relay terminal UE1. With this procedure, the connection between the remote terminal UE2 and the relay terminal UE1 is maintained until the connection between the remote terminal UE2 and the base station eNB is established (until the state becomes RRC_CONNECTED).

Then, the user equipment apparatus UE2 transmits and receives data directly to and from the base station eNB (S407, S409).

The relay terminal UE1 in accordance with this embodiment is configured as shown in FIG. 6.

In this embodiment, the connection management unit 106 releases the connection to the remote terminal UE2 in response to a connection release request from the remote terminal UE2 or the base station eNB, that is, when connection information indicating that the remote terminal UE2 is connected to the base station eNB.

The remote terminal UE2 in accordance with this embodiment is configured as shown in FIG. 7.

In this embodiment, the connection management unit 205 establishes a connection to the base station eNB when the remote terminal UE2 moves in coverage of the base station eNB. Then, the connection management unit 205 releases the connection to the relay terminal UE1 by transmitting to the relay terminal connection information indicating that the remote terminal UE2 is connected to the base station eNB.

By maintaining the connection to the relay terminal UE1 until a connection between the remote terminal UE2 and the base station eNB is established, the connection between the remote terminal UE2 and the base station eNB can be stabilized.

(5) Connection to the relay terminal UE1 or UE3 when the user equipment apparatus moves outside coverage of the base station eNB

When the user equipment apparatus UE2 moves outside coverage of the base station eNB, the user equipment apparatus UE2 can communicate with the base station eNB as a remote terminal via the relay terminal UE1 in coverage of the base station, for example.

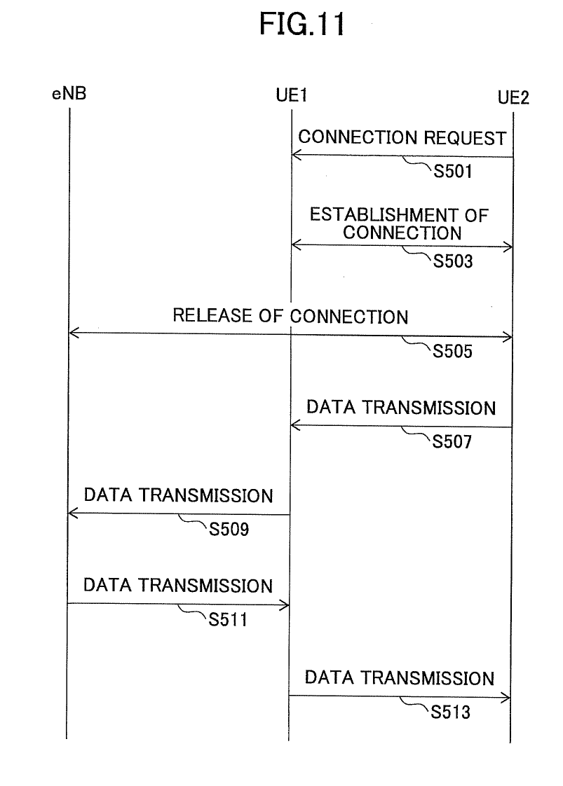

FIG. 11 shows a sequence diagram of a procedure when the remote terminal UE2 moves outside coverage of the base station eNB.

For example, the user equipment apparatus UE2 measures link quality between the user equipment apparatus UE2 and the base station eNB. When the measured link quality is degraded, the user equipment apparatus UE2 detects the relay terminal UE1 in its proximity and transmit a connection request to the detected relay terminal UE1 (S501).

When the user equipment apparatus UE2 connects to the relay terminal UE1 as a remote terminal (S503), the user equipment apparatus UE2 releases the connection to the base station eNB (S505).

Then, the remote terminal UE2 transmits and receives data to and from the base station eNB via the relay terminal UE1 (S507-S513).

According to the sequence shown in FIG. 11, while the connection in the terminal can be maintained, interference caused by communication between terminals in coverage of the base station eNB may be increased. In order to reduce interference, when the user equipment apparatus UE2 moves outside coverage of the base station eNB, part of steps S501-S513 may be performed while the connection to the base station eNB is established and the rest of the steps may be performed after the connection is released. For example, assignment of an IP address by the relay terminal can be performed in advance.

Since the remote terminal can receive a synchronization signal and broadcast information from the base station eNB, the remote terminal may perform D2D communication using D2D configuration information (for example, information about a resource pool) provided by the base station eNB. Since the relay terminal may not obtain D2D configuration information again, delay in establishing a connection can be reduced. In addition, by using the D2D configuration information for out-of-coverage communication, an increase in interference can be avoided.

The remote terminal UE2 in accordance with this embodiment is configured as shown in FIG. 7. The remote terminal UE2 may also include a quality measurement unit (not shown) configured to measure link quality between the remote terminal UE2 and the base station eNB. The link quality between the remote terminal UE2 and the base station may be determined by RSRP (Reference Signal Received Power). Alternatively, it may be determined that the link quality is degraded upon transmission of an RRC Connection Reestablishment Request, upon out of synchronization, or upon start of an RRC connection re-establishment procedure.

The connection management unit 205 establishes a connection to the relay terminal UE1 in the proximity of the user equipment apparatus UE2, when quality between the user equipment apparatus UE2 and the base station eNB is below a predetermined threshold. It should be noted that during connecting to the base station eNB, the connection management unit 205 may perform part of the connection procedure such as detection of the relay terminal UE1 in the proximity of the user equipment apparatus UE2 and assignment of an IP address by the relay terminal UE1.

By establishing a connection to the relay terminal UE1 when quality of the in-coverage user equipment apparatus is degraded, the connection between the user equipment apparatus UE2 and the base station eNB can be stabilized.

<Effects of Embodiments of the Present Invention>

According to an embodiment of the present invention, it is possible to stabilize a connection between a remote terminal UE and a base station eNB when a communication route in D2D relay is changed.

According to the solution (1) selection of the other relay terminal UE3 during the connection to the currently-connected relay terminal UE1, by allowing the remote terminal UE2 to select the relay terminal UE3 suitable for D2D relay, a link failure in D2D relay can be avoided and the connection between the remote terminal UE2 and the base station eNB can be stabilized. In addition, by allowing the remote terminal UE2 to periodically select the other relay terminal UE3, delay in selecting the other relay terminal UE3 can be reduced.

According to the solution (2) establishment of multi-links to both the currently-connected relay terminal UE1 and the other relay terminal UE3, by establishing multi-links and groupcasting data from the remote terminal UE2 to the relay terminals UE1 and UE3, the connection between the remote terminal UE2 and the base station eNB can be maintained.

According to the solution (3) continuous use of the IP address used for communication with the currently-connected relay terminal UE1, a procedure for setting an IP address according to a DHCP or using an RS/RA need not be performed between the remote terminal UE2 and the relay terminal UE3 and the connection on the IP layer between the remote terminal UE2 and the base station eNB can be maintained.

According to the solution (4) connection to the base station eNB when the relay terminal moves in coverage of the base station eNB, by maintaining the connection to the relay terminal UE1 until a connection between the remote terminal UE2 and the base station eNB is established, the connection between the remote terminal UE2 and the base station eNB can be stabilized.

According to the solution (5) connection to the relay terminal UE1 or UE3 when the user equipment apparatus moves outside coverage of the base station eNB, by establishing a connection to the relay terminal UE1 or UE3 when quality of the in-coverage user equipment apparatus is degraded, the connection between the user equipment apparatus UE2 and the base station eNB can be stabilized.

For convenience of explanation, the user equipment apparatuses (the relay terminal and the remote terminal) according to the embodiments of the present invention have been described with reference to functional block diagrams, but the user equipment apparatuses may be implemented in hardware, software, or combinations thereof. For example, the embodiments of the present invention may be implemented as a program for causing a computer to perform each function of the user equipment apparatuses according to the embodiments of the present invention, as a program for causing a computer to perform each procedure in the method according to the embodiments of the present invention, or the like. In addition, two or more functional elements may be combined as appropriate. The method according to the embodiments of the present invention may be carried out in a different order from the order shown in the embodiments.

While the approaches are described above to stabilize the connection between the remote terminal UE and the base station eNB when the communication route in D2D relay is changed, the present invention is not limited to the these embodiments, and variations, modifications, alterations, and substitutions can be made by those skilled in the art without deviating from the spirit of the present invention.

The present international application is based on and claims the benefit of priority of Japanese Patent Application No. 2015-074187 filed on Mar. 31, 2015, the entire contents of which are hereby incorporated by reference.

### DESCRIPTION OF NOTATIONS

100 relay terminal (user equipment apparatus)

101 signal transmission unit

102 signal reception unit

103 D2D communication unit

104 relay unit

105 quality measurement unit

106 connection management unit

200 remote terminal (user equipment apparatus)

201 signal transmission unit

202 signal reception unit

203 D2D communication unit

204 relay terminal selection unit

205 connection management unit

1. A user equipment apparatus acting as a relay terminal to relay data between a remote terminal and a base station, comprising:
a transmission unit configured to transmit to the remote terminal a groupcast ID which is a destination for the data;
a reception unit configured to receive a connection release request from the remote terminal; and
a connection management unit configured to release a connection to the remote terminal when the connection release request is received from the remote terminal.

2. The user equipment apparatus as claimed in claim 1, further comprising:
a quality measurement unit configured to measure link quality between the user equipment apparatus and the base station or link quality between the user equipment apparatus and the remote terminal;
wherein the transmission unit notifies the remote terminal of quality degradation when the link quality between the user equipment apparatus and the base station or the link quality between the user equipment apparatus and the remote terminal is below a predetermined threshold.

3. A user equipment apparatus acting as a remote terminal to communicate with a base station via a relay terminal with a capability of relaying data, comprising:
a connection management unit configured to establish a link between the user equipment apparatus and the relay terminal and between the user equipment apparatus and another relay terminal;
a reception unit configured to receive from the relay terminal a groupcast ID which is a destination for the data; and
a transmission unit configured to transmit the data based on the groupcast ID;
wherein the transmission unit further transmits a connection release request to the relay terminal.

4. The user equipment apparatus as claimed in claim 3, further comprising:
a relay terminal selection unit configured to select the other relay terminal when a notification of quality degradation is received from the relay terminal.

5. The user equipment apparatus as claimed in claim 3, wherein the connection management unit releases a connection to the relay terminal, when a response to the connection release request is received from the relay terminal or when a predetermined period of time has elapsed from the connection release request to the relay terminal.

6. A user equipment apparatus acting as a relay terminal to relay data between a remote terminal and a base station, comprising:
a reception unit configured to receive address information from the remote terminal, the base station, or another relay terminal; and
an IP address setting unit configured to set an IP address according to the received address information.

7. A user equipment apparatus acting as a relay terminal to relay data between a remote terminal and a base station, comprising:
a reception unit configured to receive connection information indicating that the remote terminal is connected to the base station; and
a connection management unit configured to release a connection to the remote terminal, when the connection information is received.

8. A user equipment apparatus acting as a remote terminal to communicate with a base station via a relay terminal with a capability of relaying data, comprising:
a connection management unit configured to connect to the base station when the user equipment apparatus moves in coverage of the base station; and
a transmission unit configured to transmit to the relay terminal connection information indicating that the user equipment apparatus is connected to the base station;
wherein the connection management unit releases a connection to the relay terminal, when the connection information indicating that the user equipment apparatus is connected to the base station is transmitted to the relay terminal.

9. A user equipment apparatus for communicating with a base station, comprising:
a quality measurement unit configured to measure link quality between the user equipment apparatus and the base station;
a transmission unit configured to transmit a connection request to a relay terminal for relaying data between the user equipment apparatus and the base station, when the link quality between the user equipment apparatus and the base station is below a predetermined threshold; and
a connection management unit configured to establish a connection to the relay terminal.

10. The user equipment apparatus as claimed in claim 4, wherein the connection management unit releases a connection to the relay terminal, when a response to the connection release request is received from the relay terminal or when a predetermined period of time has elapsed from the connection release request to the relay terminal.
